(19) United States
(12) Patent Application Publication
(10) Pub. No.: US 2014/0121941 A1
(43) Pub. Date: May 1, 2014

(54) Intake Pressure Control In Internal Combustion Engine

(71) Applicant: CATERPILLAR, INC., Peoria, IL (US)

(72) Inventors: Arvind Sivasubramanian, Peoria, IL (US); Christopher F. Gallmeyer, Peoria, IL (US)

(73) Assignee: Caterpillar, Inc., Peoria, IL (US)

(21) Appl. No.: 13/662,805

(22) Filed: Oct. 29, 2012

(51) Int. Cl. F02D 41/26

(52) U.S. Cl. 701/103

(57) ABSTRACT

Controlling intake pressure in an internal combustion engine includes calculating a proportional control term based on a difference between actual and desired intake pressure, determining choke and waste gate position values responsive to the proportional control term, and commanding a change in position of the choke or waste gate responsive to the corresponding position value to adjust actual intake pressure toward desired intake pressure. Related apparatus and control logic is also disclosed.

### TECHNICAL FIELD

The present disclosure relates generally to controlling intake pressure in an internal combustion engine, and relates more particularly to controlling intake pressure via positioning a choke and a waste gate responsive to a common proportional control term.

### BACKGROUND

Internal combustion engines are well known and widely used for propelling vehicles, providing electrical power, driving pumps, compressors, and in all manner of other applications. In certain internal combustion engines, especially those used in heavier duty applications, a turbocharger is employed to recover energy from exhaust gases for the purpose of compressing intake air supplied to the engine for combustion with a fuel. In most instances, pressurizing the intake air enables the engine to extract a greater quantity of the potential energy contained in a given amount of fuel than would otherwise occur, according to well known principles.

In many engine operating strategies, the power output and speed of the engine depends upon an amount of fuel delivered to the cylinders in each engine cycle. More than enough air to support successful combustion of a range of fueling amounts is typically available. In certain other instances, however, such as lean burn engine operation where the fueling amount is less than a stoichiometric amount of fuel for a given quantity of intake air, engine operation can be sensitive to both the fueling amount and a ratio of the fuel to air. Since lean burn operation is employed for various purposes, notably reduction of certain emissions, increased or decreased intake air pressure such as from varying turbocharger speed can have undesired effects. If too much air pressure is provided, the engine can experience ignition problems. If too little, combustion of the relatively richer mixture of fuel and air can compromise emissions.

For these and other reasons, various strategies have been proposed over the years for selectively controlling a pressure of intake air, apart from rotation speed of a turbocharger. U.S. Pat. No. 6,055,811 to Maddock, et al. proposes an apparatus and method for controlling the air flow into an engine. Maddock, et al. teach that a position of a choke valve and a waste gate respectively affecting intake pressure and exhaust pressure can be used to vary air pressure within an intake manifold. It appears that Maddock, et al. utilize separate controllers for each of the choke and waste gate, and hand off control over the intake air flow based upon operating conditions of the engine. While the strategy proposed by Maddock, et al. may perform sufficiently well, there is always room for improvement, particularly with regard to the complexity of that control strategy.

### SUMMARY

In one aspect, a method of controlling intake pressure in an internal combustion engine includes calculating a proportional control term based on a difference between an actual intake pressure and a desired intake pressure, in an intake conduit of the internal combustion engine. The method further includes determining a choke position value for a choke within the intake conduit responsive to the proportional control term, and determining a waste gate position value for a waste gate within an exhaust conduit of the internal combustion engine responsive to the proportional control term. The method still further includes commanding a change in position of at least one of the choke and the waste gate responsive to the corresponding position value, such that the actual intake pressure is adjusted toward the desired intake pressure.

In another aspect, an internal combustion engine system includes an engine having an engine housing, an intake conduit for conveying combustion air to the engine housing, and an exhaust conduit for conveying exhaust gases from the engine housing. The engine system further includes a choke within the intake conduit and having a choke actuator coupled therewith, and a waste gate within the exhaust conduit and having a waste gate actuator coupled therewith. The engine system still further includes an electronic controller in control communication with each of the choke actuator and the waste gate actuator, and being configured to calculate a proportional control term based on a difference between an actual intake pressure and a desired intake pressure, in the intake conduit. The electronic controller is further configured to determine each of a choke position value and a waste gate position value responsive to the proportional control term, and to command a change in position of at least one of the choke and the waste gate responsive to the corresponding position value, such that the actual intake pressure is adjusted toward the desired intake pressure.

In still another aspect, an intake pressure control system for an internal combustion engine includes a choke actuator configured to couple with a choke positionable within an intake conduit of an internal combustion engine, and a waste gate actuator configured to couple with a waste gate positionable within an exhaust conduit of the internal combustion engine. The control system further includes an electronic controller in control communication with each of the choke actuator and the waste gate actuator, and being configured to calculate a proportional control term based on a difference between an actual intake pressure and a desired intake pressure, in the intake conduit. The electronic controller is further configured to determine each of a choke position value and a waste gate position value responsive to the proportional control term. The electronic controller is further configured to command a change in position of at least one of the choke and the waste gate responsive to the corresponding position value, such that the actual intake pressure is adjusted toward the desired intake pressure.

### BRIEF DESCRIPTION OF THE DRAWINGS

FIG. 1 is a schematic view of an engine system, according to one embodiment;

FIG. 2 is a block diagram of a control strategy, according to one embodiment; and

FIG. 3 is a flowchart illustrating an example control process, according to one embodiment.

### DETAILED DESCRIPTION

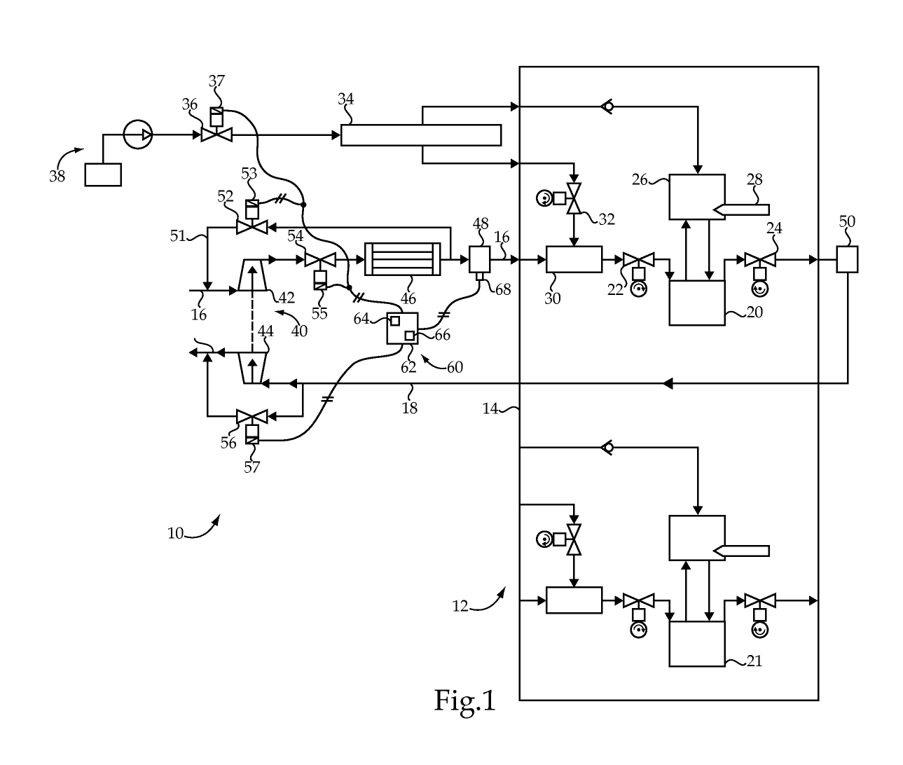

Referring to FIG. 1, there is shown an internal combustion engine system 10 according to one embodiment. Engine system 10 includes an engine 12 having an engine housing 14 defining a plurality of combustion cylinders, two of which are shown and labeled via reference numerals 20 and 21. Engine 12 may have any number of cylinders, each similarly configured, and thus the present description primarily of cylinder 20 and associated components should be understood analogously to refer to any of the combustion cylinders of engine 12. Engine housing 12 further defines a plurality of precombustion chambers, each fluidly connected with one of the plurality of cylinders, one of which is shown via reference numeral 26. Engine system 10 may further include a plurality of spark plugs 28 each extending into one of the plurality of precombustion chambers, for spark igniting a mixture of fuel and air therein to induce ignition of a main charge of fuel and air within the corresponding cylinder.

A cam actuated intake valve 22 and a cam actuated exhaust valve 24 are associated with cylinder 20 to provide fluid communication between an intake manifold 48 and cylinder 20, and an exhaust manifold 50 and cylinder 20, respectively. In a practical implementation strategy, engine 12 is a gaseous fuel engine wherein a gaseous fuel such as natural gas, landfill gas, or another gaseous fuel is supplied to cylinder 20 via a fuel port 30 positioned fluidly between intake manifold 48 and intake valve 22. System 10 may further include a gaseous fuel supply 38 which supplies the gaseous fuel to a gaseous fuel common rail 34 in a conventional manner, to convey the same to cylinder 20 and the other cylinders of engine 12. A gaseous fuel admission valve 32, which may also be cam actuated, is provided to control supplying of gaseous fuel from common rail 34 to fuel port 30. Common rail 34 may also be fluidly connected to precombustion chamber 26 in a manner that will be familiar to those skilled in the art. A fuel valve 36 having a fuel valve actuator 37 is positioned fluidly between supply 38 and common rail 34 and can be operated to control a pressure of gaseous fuel within common rail 34.

Engine 12 may further include an intake conduit 16 for conveying combustion air to engine housing 14, and an exhaust conduit 18 for conveying exhaust gases from engine housing 14. Engine system 10 may further include a turbocharger 40 having a compressor 42 configured to compress intake air for supplying to engine 12 via intake conduit 16, and a turbine 44 operated via a pressure of exhaust gases conveyed through exhaust conduit 18. A choke 54 such as a butterfly valve-type choke, is positioned within intake conduit 16 and has a choke actuator 55 coupled therewith. A waste gate 56 is positioned within exhaust conduit 18 and has a waste gate actuator 57 coupled therewith. Compressed intake air may pass through an aftercooler 46 prior to delivery to intake manifold 48, in a conventional manner. A bypass conduit 51 provides a route for compressed air to be returned from a location in intake conduit 16 downstream for aftercooler 46 to a location upstream of compressor 42. A compressor bypass valve 52 having an actuator 53 is positioned within conduit 51 to enable opening and closing of conduit 51 to be selectively controlled.

Engine system 10 may further include an intake pressure control system 60 having an electronic controller 62 in control communication with each of choke actuator 55 and waste gate actuator 57. Control system 60 may further include an intake manifold pressure sensor 68 in communication with electronic controller 62, which may also be in control communication with each of actuators 37, 53, 55 and 57, as further described herein. In a manner and for purposes further discussed herein, electronic controller 62 may be configured to control intake air pressure in engine system 10 via selectively adjusting positions of choke 54 and waste gate 56, either simultaneously or at different times to maintain or obtain a desired intake manifold pressure corresponding to a desired lean ratio of air to gaseous fuel in engine 12.

Those skilled in the art will appreciate that lean burn operation, notably as used in gaseous fuel internal combustion engines, can have desirable effects on emissions. Given the use of gaseous fuel, and delivery of the fuel via an admission valve to a port in an intake conduit for an engine as in the presently contemplated strategies, disruptions or uncertainty in intake manifold pressure can result in a ratio of air to gaseous fuel other than what is optimal. In other words, unlike certain liquid fueled engines, and fuel injected engines generally whether gaseous fuel or liquid fuel, variations in intake manifold pressure can make it difficult to sustain a desired air to gaseous fuel ratio. Where intake manifold pressure is lower than optimal, more fuel than is needed may be delivered, resulting in a fuel and air mixture relatively rich and potentially compromising emissions. Where intake manifold pressure is higher than optimal, too little fuel may be delivered and ignition problems may result. The present disclosure contemplates the control of choke 54 and waste gate 56, and in a manner heretofor unknown, to control intake pressure and thus air to fuel ratio in a manner than is both effective and not overly computationally complex or unreliable.

To these and other ends, electronic controller 62 may be configured to calculate a proportional control term based on a difference between an actual intake pressure and a desired intake pressure, in intake conduit 16, and to control each of choke 54 and waste gate 56 in response to the calculated proportional control term. In particular, electronic controller 62 may be configured to determine a choke position value and a waste gate position value responsive to the proportional control term, and to command a change in position of at least one of choke 54 and waste gate 56 responsive to the corresponding position value, such that actual intake pressure is adjusted toward desired intake pressure. Electronic controller 62 may further include a computer readable memory 66 storing computer executable code, and a data processor 64 configured via executing the computer executable code to calculate the proportional control term, as a proportional integral (PI) controller. As will be further apparent from the following description, exactly one PI controller is used to control both choke 54 and waste gate 56, in particular via outputting actuator control signals to actuators 55 and 57 such that two separate actuators function much as a single actuator would. This strategy contrasts with earlier designs such as Maddock et al., discussed above, where separate and independent control logic, and multiple proportional controllers plus hand-off logic between the controllers, were used to control a waste gate and a choke. According to the present disclosure, no special hand-off control logic is required at all.

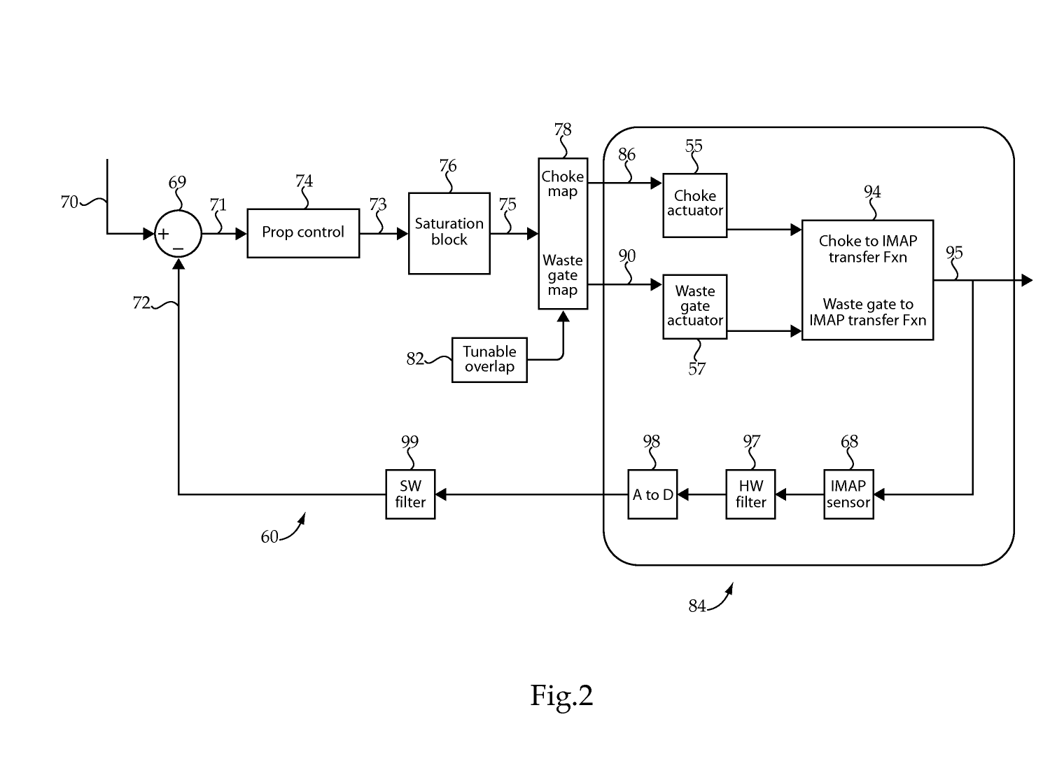

Referring also now to FIG. 2, there is shown a block diagram illustrating the presently described control strategy in further detail. In FIG. 2, the plant 84 includes choke actuator 55 and waste gate actuator 57, and choke to intake manifold air pressure (IMAP) and waste gate to IMAP transfer functions 94. Intake manifold pressure is represented via reference numeral 95, sensed by pressure sensor 68. An output of pressure sensor 68 is filtered via a hardware filter 97 and processed via an analog to digital converter 98. An output of converter 98 may be processed via a software filter 99 to generate an actual intake manifold pressure signal 72. At an error calculation 69, a desired intake manifold pressure signal 70 is compared with signal 72 to generate an error signal 71. Error signal 71 is used as the basis for calculating a proportional control term as described herein, in a proportional control block 74. In control block 74, the proportional control term may be calculated in response to error signal 71 to produce a controller output 73. Output 73 may be processed in a saturation block 76 to produce a bounded output signal 75.

It will be recalled that control system 60 may determine a choke position value and a waste gate position value each responsive to the proportional control term. In one practical implementation strategy, the corresponding position values may be determined from a choke map and a waste gate map in a control block 78, each of the maps having as a coordinate the proportional control term. The choke map and waste gate map may be stored on memory 66, for example. Electronic controller 62 may accordingly look up actuator control signal values for actuators 55 and 57 in control block 78, and responsively output a choke actuator control signal 86 to choke actuator 55 and a waste gate actuator signal 90 to waste gate actuator 57. In alternative strategies, electronic controller 62 could determine signals 86 and 90 via appropriate equations determined via standard empirical techniques.

As noted above, control of both actuators 55 and 57 can be based upon calculation of the same proportional control term, for example a proportional integral control term, and no special logic is required to enable handing off between the choke and waste gate, as control transitions seamlessly from one to the other. In a practical implementation strategy, this is enabled at least in part by adjusting positions of one or both of choke 54 and waste gate 56 responsive to a value of the proportional control term. The choke map and waste gate map utilized in control block 78 may be populated such that when the proportional control term has a value within a first part of a range, choke actuator 55 is commanded to adjust a position of choke 54, and where the value is in a second part of the range waste gate actuator 57 is commanded to change the position of waste gate 56. For example, after signal 75 is produced in control block 76 the bounded value of the proportional control term might be anywhere from 0 to 2. If the value is from 0 to 1, electronic controller 62 may command a change in position of choke 54 but not waste gate 56. If a value of the proportional control term is from 1 to 2, for instance, electronic controller 62 may command a change in position of waste gate 56 but not choke 54.

Choke and waste actuators 55 and 57 will typically receive an actuator control signal every time the control loop depicted in FIG. 2 is executed. Accordingly, if the proportional control term is within the first part of the range, electronic controller 62 may be understood as commanding a changed position of choke 54 and a steady position of waste gate 56, whereas if the proportional control term is in the second part of the range electronic controller 62 may be understood as commanding a steady position of choke 54 and a changed position of waste gate 56. Another way to understand these principles is that control commands may be outputted to each of choke actuator 55 and waste gate actuator 57 every time the control loop is executed, but the actuators will interpret the control signals as a changed position command or a steady position command, depending upon a value of the actuator control signals as determined in control block 78. In certain embodiments, if the value of the proportional control terms is within a third part of the range between the first and second parts, for example from 0.9 to 1.1, electronic controller 62 may command a change in position of both choke 54 and waste gate 56. The breadth of this range may be configurable, and to this end a tunable overlap control block 82 is shown in FIG. 2. A technician might therefore be provided with the capability to adjust the breadth of the third part of the range, depending upon performance requirements and other factors such as expected duty cycles and speed ranges of engine system 10.

### INDUSTRIAL APPLICABILITY

In a turbocharged internal combustion engine, intake pressure will typically be dependant at least in part upon a torque applied to the turbine by exhaust gases. Changes in turbine speed will tend to increase or decrease compressor speed, thus changing a pressure of the intake air conveyed to the combustion cylinders. For reasons discussed above, in certain engines it may be desirable to provide a separate, independent control over the intake pressure such that a ratio of air to fuel can be maintained or adjusted as desired in a manner decoupled from other factors impacting intake pressure, such as compressor speed. Control of choke 54 and waste gate 56 enable this flexibility. When engine system 10 is just starting or running at idle, choke 54 will typically be closed as much as possible while waste gate 56 may be fully open. While some turbocharger lag can be expected, as engine speed and load increase, turbine speed and compressor speed will increase, and choke 54 may be gradually opened until it is at a fully opened position. When choke 54 cannot be opened any further, or is approaching a fully open position where its authority over intake pressure begins to be reduced, waste gate 56 may begin to be closed. As discussed above, certain earlier strategies attempted to monitor or estimate a point at which choke authority began to decrease, or a point at which the choke was fully open, and then begin attempting to control intake pressure via the waste gate, and used some control logic to manage the hand-off. When engine speed decreased, the hand-off process would essentially occur in reverse. Superposed upon the opening-closing aspects of the choke and waste gate responsive to engine speed could be adjustments open or closed to maintain intake pressure or adjust it as desired.

In the present disclosure, no hand-off between the choke and waste gate is required as the control seamlessly transitions based upon the value of the proportional control term. Since the proportional control term is calculated in response to error signal 71, it will be typically be desirable to provide electronic controller 62 some means to account for where along a continuum of choke control to waste gate control system 10 is operating. This can be accomplished via direct monitoring of intake manifold pressure and/or routine gain scheduling in control block 74. Accordingly, where intake manifold pressure is relatively lower, within a range of authority of choke 54, the proportional control term will be relatively lower in value while still proportional to the error signal. Where intake manifold pressure is relatively higher, and system 10 is operating where intake pressure is within the authority of waste gate 56, the proportional control term will be relatively greater in value. Saturation block 76 will bound the proportional control term to be within a range that can actually be acted upon, in other words, causing, say, a value of 2.2 to be reduced to 2.0. Calibration and configuration of electronic controller 62 with regard to calculating the proportional control term and setting fixed and scheduled gains will be within routine skill in view of the teachings set forth herein.

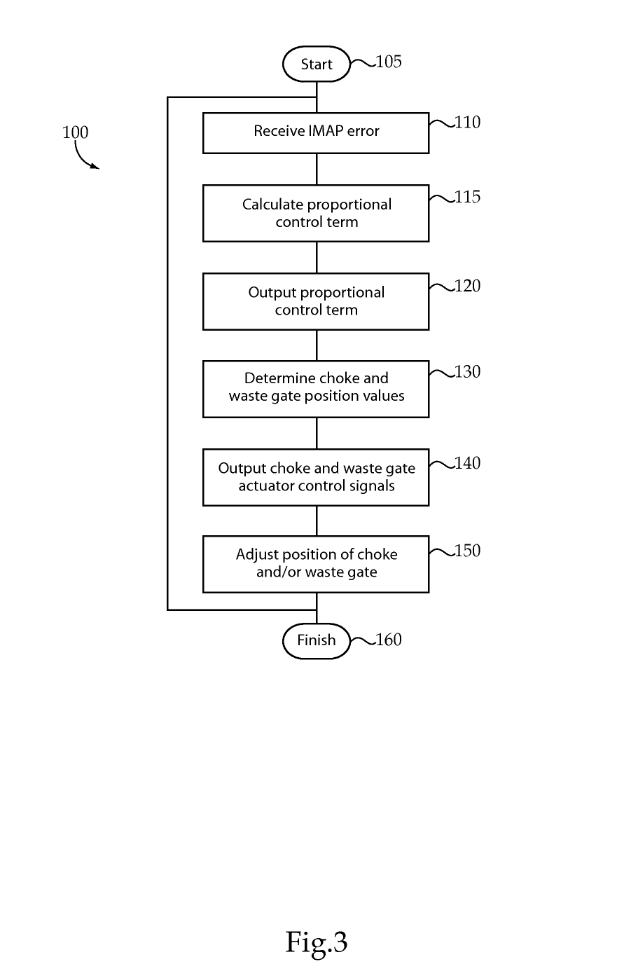

Referring also now to FIG. 3, there is shown a control process generally analogous to the execution of the control loop depicted in FIG. 2 by way of a flowchart 100. The process of flowchart 100 will start at step 105 and proceed to step 110 to receive the IMAP error. From step 110, the process may proceed to step 115 to calculate the proportional control term. From step 115, the process may proceed to step 120 to output the proportional control term, and to step 130 to determine the choke and waste gate position values as discussed herein. From step 130, the process may proceed to step 140 to output the choke and waste gate actuator control signals. At step 150, the position of choke 54 and/or waste gate 56 is adjusted. From step 150, the process may loop back to execute again, or may finish at step 160.

Returning briefly to FIG. 1, one further feature of the present disclosure relates to the ability to control choke 54 and waste gate 56 to obtain a desired intake pressure while bypass conduit 51 is open. It will be recalled that intake pressure is being sensed directly via sensor 68, and part of the consideration in determining the control commands for actuators 55 and 57. Accordingly, since conduit 51 can affect intake pressure by allowing pressurized intake air to be dumped backed into intake conduit 16 upstream of compressor 42, system 10 can naturally continue to control intake pressure despite perturbations that might occur based upon the use of bypass valve 52. Known systems attempting to control a choke and/or a waste gate responsive to engine operating factors such as speed and load do not have such capability, or could do so only via control strategies likely complex or computationally intensive.

The present description is for illustrative purposes only, and should not be construed to narrow the breadth of the present disclosure in any way, Thus, those skilled in the art will appreciate that various modifications might be made to the present disclosed embodiments without departing from the full and fair scope and spirit of the present disclosure. Other aspects, features and advantages will be apparent upon an examination of the attached drawings and appended claims.

What is claimed is:

1. A method of controlling intake pressure in an internal combustion engine comprising the steps of:
calculating a proportional control term based on a difference between an actual intake pressure and a desired intake pressure, in an intake conduit of the internal combustion engine;
determining a choke position value for a choke within the intake conduit responsive to the proportional control term;
determining a waste gate position value for a waste gate within an exhaust conduit of the internal combustion engine responsive to the proportional control term; and
commanding a change in position of at least one of the choke and the waste gate responsive to the corresponding position value, such that the actual intake pressure is adjusted toward the desired intake pressure.

2. The method of claim 1 wherein the step of calculating further includes calculating the proportional control term based on an error between an actual intake manifold pressure, and a desired intake manifold pressure corresponding to a desired lean ratio of air to gaseous fuel in the internal combustion engine.

3. The method of claim 2 wherein the steps of determining include determining the corresponding position values from a choke map and a waste gate map each having as a coordinate the proportional control term.

4. The method of claim 2 wherein the step of commanding further includes commanding a change in position of the choke but not the waste gate, if a value of the proportional control term is within a first part of a range, and commanding a change in position of the waste gate but not the choke if the value is within a second part of the range.

5. The method of claim 4 wherein the step of commanding further includes outputting control commands to each of a choke actuator coupled with the choke and a waste gate actuator coupled with the waste gate.

6. The method of claim 4 wherein the step of commanding further includes commanding a change in position of both the choke and the waste gate, if the value of the proportional control term is within a third part of the range between the first and second parts.

7. The method of claim 2 wherein the step of commanding takes place while a compressor bypass valve in the internal combustion engine is in an open position.

8. An internal combustion engine system comprising:
an engine including an engine housing, an intake conduit for conveying combustion air to the engine housing, and an exhaust conduit for conveying exhaust gases from the engine housing;
a choke within the intake conduit and having a choke actuator coupled therewith;
a waste gate within the exhaust conduit and having a waste gate actuator coupled therewith;
an electronic controller in control communication with each of the choke actuator and the waste gate actuator;
the electronic controller being configured to calculate a proportional control term based on a difference between an actual intake pressure and a desired intake pressure, in the intake conduit, and being further configured to determine each of a choke position value and a waste gate position value responsive to the proportional control term; and
the electronic controller being further configured to command a change in position of at least one of the choke and the waste gate responsive to the corresponding position value, such that the actual intake pressure is adjusted toward the desired intake pressure.

9. The engine system of claim 8 wherein the electronic controller further includes a computer readable memory storing computer executable code, and a data processor configured via executing the computer executable code to calculate the proportional control term as a PI controller.

10. The engine system of claim 9 wherein the computer readable memory stores a choke map and a waste gate map each having as a map coordinate the proportional control term.

11. The engine system of claim 10 wherein each of the choke and waste gate position values includes an actuator control signal value, and the electronic controller is further configured to look up the actuator control signal values in the corresponding choke or waste gate map.

12. The engine system of claim 8 wherein the electronic controller is further configured to command a changed position of the choke and a steady position of the waste gate, if a value of the proportional control term is within a first part of a range, and to command a steady position of the choke and a changed position of the waste gate, if the value of the proportional control term is within a second part of the range.

13. The engine system of claim 12 wherein the electronic controller is further configured to command a changed position of both the choke and the waste gate, if the value of the proportional control term is between the first and second parts of the range.

14. The engine system of claim 8 wherein the intake conduit includes an intake manifold, and further comprising an intake manifold pressure sensor, and wherein the electronic controller is further configured to calculate the proportional control term based on an error between an actual intake manifold pressure as indicated by the intake manifold pressure sensor, and a desired intake manifold pressure corresponding to a desired lean ratio of air to gaseous fuel in the internal combustion engine.

15. The engine system of claim 14 wherein the engine housing defines a plurality of cylinders, a plurality of precombustion chambers each fluidly connected to one of the plurality of cylinders, and a plurality of spark plugs each extending into one of the plurality of precombustion chambers, and the engine system further comprising a common gaseous fuel rail and a plurality of gaseous fuel admission valves each positioned fluidly between the common gaseous fuel rail and one of the plurality of cylinders.

16. The engine system of claim 8 further comprising a compressor bypass conduit and a compressor bypass valve within the compressor bypass conduit.

17. An intake pressure control system for an internal combustion engine comprising:
a choke actuator configured to couple with a choke positionable within an intake conduit of an internal combustion engine;
a waste gate actuator configured to couple with a waste gate positionable within an exhaust conduit of the internal combustion engine;
an electronic controller in control communication with each of the choke actuator and the waste gate actuator;
the electronic controller being configured to calculate a proportional control term based on a difference between an actual intake pressure and a desired intake pressure, in the intake conduit, and being further configured to determine each of a choke position value and a waste gate position value responsive to the proportional control term;
the electronic controller being further configured to command a change in position of at least one of the choke and the waste gate responsive to the corresponding position value, such that the actual intake pressure is adjusted toward the desired intake pressure.

18. The control system of claim 17 wherein the electronic controller includes a computer readable memory storing a choke map and a waste gate map each having as a coordinate the proportional control term.

19. The control system of claim 18 wherein the computer readable memory stores computer executable code, and the electronic controller includes a data processor configured via executing the computer executable code to calculate the proportional control term as a PI controller.

20. The control system of claim 19 wherein the electronic controller is further configured to command a changed position of the choke and a steady position of the waste gate, if a value of the proportional control term is within a first part of a range, and to command a steady position of the choke and a changed position of the waste gate, if the value of the proportional control term is within a second part of the range.
